(19) United States
(12) Patent Application Publication
(10) Pub. No.: US 2010/0101399 A1
(43) Pub. Date: Apr. 29, 2010

(54) Electromagnetic Pickup for stringed musical instruments

(76) Inventor: Kenneth Calvet, Lake Oswego, OR (US)

Correspondence Address: KENNETH M CALVET, 5225 JEAN RD. #308, LAKE OSWEGO, OR, 97035, US

(21) Appl. No.: 12/290,203

(22) Filed: Oct. 28, 2008

(51) Int. Cl. G10H 3/18

(52) U.S. Cl. 84/726

(57) ABSTRACT

An electromagnetic pickup adapted for use with a multistringed musical instrument having strings formed of a ferromagnetic material having a first wire coil wound in a first direction in an elongated oval shape wherein the first coil has a geometrical dimension along its elongated axis which exceeds the distance between the first and second strings wherein the first coil includes an opening which extends through the interior thereof, a second wire coil wound in a first direction in an elongated oval shape wherein the second coil has a geometrical dimension along its elongated axis which exceeds the distance between the third and fourth strings wherein the second coil includes an opening which extends through the interior thereof, a third wire coil wound in a first direction in an elongated oval shape wherein the third coil has a geometrical dimension along its elongated axis which exceeds the distance between the fifth and sixth strings wherein the third coil includes an opening which extends through the interior thereof, a fourth wire coil wound in a first direction in an elongated oval shape wherein the fourth coil has a geometrical dimension along its elongated axis which exceeds the distance between the first and sixth strings wherein the first coil includes an opening which extends through the interior thereof, and wherein said first, second and third coil are positioned in a side-by-side arrangement and wherein said fourth coil encompasses said first, second and third coil, a permanent magnet assembly which is positioned in the openings of said coils with one pole positioned in a magnetic coupling relationship with the strings of the multistringed instrument and with the other pole positioned so as to be remote from the string and a circuit for electrically connecting the first coil, the second coil, the third coil and the fourth coil wherein the coil assembly applies a magnetic field across the strings which is intercepted by the vibrating strings to produce an electrical signal is shown.

### BACKGROUND OF THE INVENTION

1. Field of the Invention

The present invention relates to electrical pickups adapted for use with multistringed musical instruments and, more particularly, relates to an electromagnetic pickup adapted for use with a multistringed musical instrument having strings formed of a ferromagnetic material to produce and output signal, the amplitude of frequency of which is representative of the vibrations of ferromagnetic strings. In the preferred embodiment, an electromagnetic pickup is adapted for use with a guitar.

2. Description of the Prior Art

The use of electrical pickups for stringed musical instruments having ferromagnetic strings is well known in the art. One electromagnetic pickup for stringed musical instruments is described in the U.S. Pat. No. 4,133,243 and comprises a pickup assembly utilizing a single coil means, and a plurality of magnet members associated with the strings of an instrument. The use of an electromagnetic pickup having a plurality of coils which are positioned in a side-by-side relationship and having permanent magnet members is discussed in U.S. Pat. Nos. 3,715,446; 3,711,619; 3,983,778. An electromagnetic pickup having a coil formed by a first and second windings wound in parallel on the same coil bobbin, one on top of the other, is disclosed in U.S. Pat. No. 3,711,619.

### SUMMARY OF THE INVENTION

The invention relates to a new, novel and unique electrical pickup for a stringed musical instrument having ferromagnetic strings. In the preferred embodiment, the electrical pickup includes a trio of transversely spaced elongated coils encompassed by a single elongated coil arranged to have the pole pieces are disposed in each elongated cavity having an end piece adjacent the permanent magnet and enclosed by each coil wherein the other opposite end face of one of the pair of magnetic pole pieces is adapted to be positioned in a spaced relationship to the ferromagnetic strings to define a magnetic reluctance path between each of the ferromagnetic strings to the permanent magnet wherein the reluctance path includes the predetermined air gap, the magnetic pole pieces having a pre-selected permeability and a portion of the permanent magnet member.

The present invention overcomes several of the known disadvantages of the prior art electrical pickups. The electromagnetic pickups having a single coil wrapped around a plurality of magnet members have in increased capacitance and increased inductance which inhibits the capability of reproduction of higher order harmonics and thereby reduces the quality of the sound produced by the instrument. Another disadvantage of prior art is that the coil is not placed in an optimal relationship to the magnetic members to make better use of the more dense magnetic flux which occurs closer to the magnetic members and in all directions from the magnetic members. The use of a multi coil pickup provides greater flexibility in controlling the qualities of the sound produced by the multistringed instrument having strings formed of a ferromagnetic material.

In the present invention, the electromagnetic pickup assembly can include a coil form assembly in combination with permanent magnet members, which results in an improved assembly having separate elements rather than an assembly having one or more monolithic magnet members having wire wound there around for the coil in the manner as disclosed in U.S. Pat. No. 3,657,461. One advantage of the present invention is that the magnetic reluctance of the path extending from the coils to the ferromagnetic strings comprises a permanent magnet member, a magnetic pole piece and an air gap.

Another advantage of the present invention is that by selectively varying the geometrical dimensions of the magnet material, the pole piece and the air gap, a wide range of output sounds can be obtained.

A still further advantage of the present invention is that the coil design reduces the inductance value of the coil assembly.

A still further advantage of the present invention is that the placement of the coils makes better use of the magnetic flux fields available which increases the signal quality.

A still further advantage of the present invention is the coil design lends itself to the ability to “tune” the coil assembly for a desired response by varying the amount of turns per individual coil.

A still further advantage of the present inventions is that the entire coil assembly can be encapsulated in housing and a flatwork so as to be fully enclosed.

A still further advantage of the present invention is that the coil assembly may be connected with other coil assemblies to create a humbucking configuration.

A still further advantage of the present invention is that the coil assembly can have the pole pieces exposed so as to be adjacent to the ferromagnetic strings of a multistringed instrument wherein the entire assembly can be potted in a standard potting compound.

A still further advantage of the present invention is that the output signal characteristics of the electromagnetic pickup and the amplified sounds produced there-from can be varied over a wide range of response, smoothness and retention qualities by controlling the length and position of the cylindrically shaped permanent magnet members relative to the ferromagnetic strings.

A still further advantage of the present invention is that a method for producing an output signal is shown utilizing electromagnetic pickup wherein the reluctance path characteristic is determined by a permanent magnet member located partially in the opening in the coil, a magnetic pole piece located partially in the coil and an air gap located between the top of the coil assembly and the ferromagnetic strings.

A still further advantage of the present invention is that the electromagnetic pickup assembly may have a coil form assembly which enables the coils to be wound separately and used in an assembly with one or more permanent magnets.

### BRIEF DESCRIPTION OF THE DRAWINGS

The foregoing and other advantages and features of this invention will become apparent from the following description of the preferred embodiment. When considered together with the illustrations and accompanying drawings, which includes the following figures.

FIG. 1 is a pictorial representation of a multistringed instrument in the form of a guitar having an electromagnetic pickup, using the teachings of this invention, positioned at a predetermined spaced relationship from the ferromagnetic strings of the instrument.

FIG. 2 is an exploded view of one embodiment of electromagnetic pickup using the teachings of the present invention.

FIG. 3 is a cross sectional side view of one embodiment of the electromagnetic pickup using the teachings of the present invention.

FIG. 4 is an illustration showing a coil assembly connecting means for a single coil configuration.

FIG. 5 is an illustration showing a coil assembly connecting means for a humbucking configuration.

### DETAILED DESCRIPTION OF THE PREFERRED EMBODIMENTS

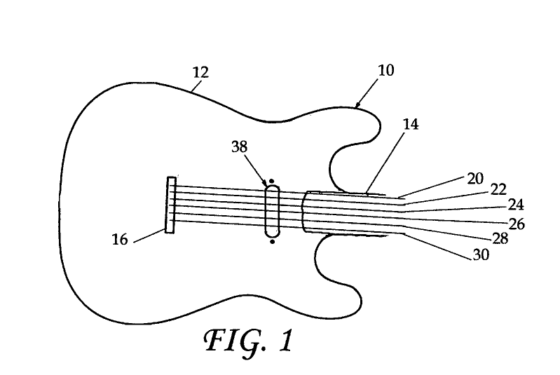

Referring to FIG. 1 illustrates a guitar shown generally by the arrow 10 comprising a body 12, neck 14, bridge assembly 16, a plurality of strings 20, 22, 24, 26, 28, 30, and the electromagnetic pickup shown by arrow 38. The strings 20, 22, 24, 26, 28, and 30 are formed of a ferromagnetic material. Typically, the strings 20, 22, 24, 26, 28, 30 inclusive, are graduated in diameter, as is known in the art. The ferromagnetic strings are capable of being magnetized by the electromagnetic pickup 38, as will be described hereinafter. Although the disclosure set forth herein relates to a six steel stringed guitar, any multistringed instrument having strings formed of a ferromagnetic material may utilize the electromagnetic pickup described herein.

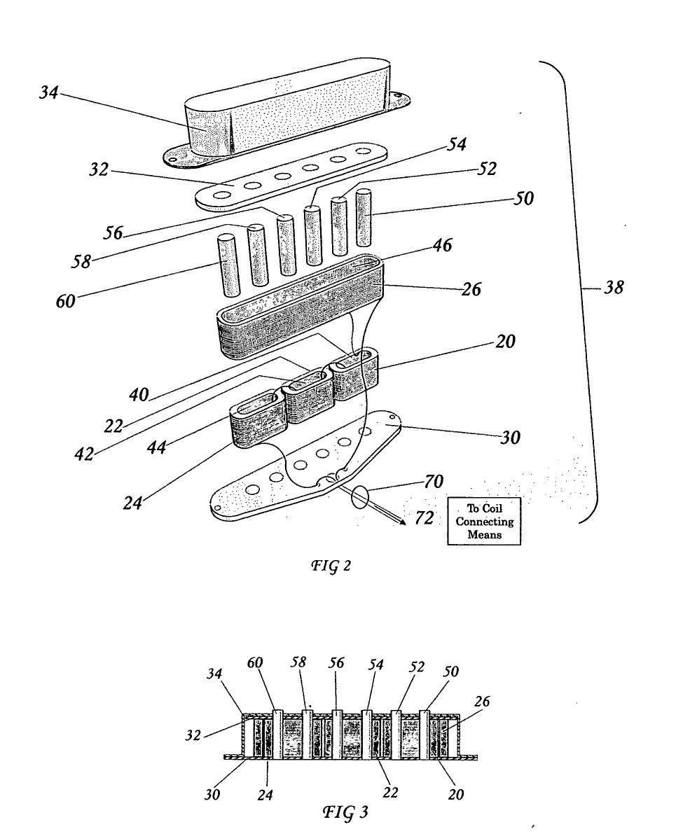

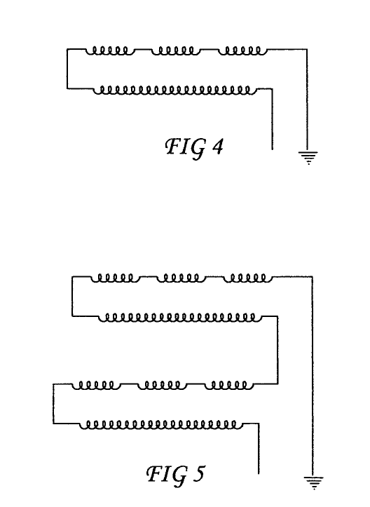

Referring to FIG. 2 one embodiment of the electromagnetic pickup shown by arrow 38 is illustrated in the exploded view. After assembly, the electromagnetic pickup 38 is an integral unit, as illustrated in FIG. 3.

In the embodiment of FIG. 2, the electromagnetic pickup 38 has a first coil 20, a second coil 22, a third coil 24, each axially spaced elongated coils having wire wound in a predetermined direction and in an elongated oval shape having a major axis and a minor axis. The first coil 20 has a first geometrical dimension along the major axis which exceeds the distance between the first and second permanent magnetic pole pieces 50 and 52 wherein the first coil includes an opening 40 which extends through the interior thereof. The second coil 22 has a first geometrical dimension along the major axis which exceeds the distance between the third and fourth permanent magnetic pole pieces 54 and 56 wherein the second coil includes an opening 42 which extends through the interior thereof. The third coil 24 has a first geometrical dimension along the major axis which exceeds the distance between the fifth and sixth permanent magnetic pole pieces 58 and 60 wherein the third coil includes an opening 44 which extends through the interior thereof.

A fourth coil 26, is an axially spaced elongated coil having wire wound in a predetermined direction and in an elongated oval shape having a major and minor axis. The fourth coil encompasses the first coil 20, second coil 22, and third coil 24 wherein the fourth coil includes an opening 46 which extends through the interior thereof as illustrated in FIG. 2. Thus the elongated axis of the coil extends substantially normal to the width of the strings 20 and 30, inclusive of FIG. 1.

A coil assembly comprising of support means using a substantially flat material or flatwork comprising of a top structure 32, and a bottom structure 30, a cover 34, and means to electrically couple the coils 70, 72.

What is claimed is:

1. An electromagnetic pickup adapted for use with a multistringed musical instrument having strings formed of ferromagnetic material comprising of:
(a) a first coil wound in a predetermined direction and in an elongated oval shape having a major and minor axis. Said first coil having a first geometrical distance along the major axis which exceeds the distance between the first and second strings of a multistringed musical instrument adapted to use the electromagnetic pickup and a second geometrical distance along the minor axis which is substantially less than that along the major axis, said first coil including means defining a first opening through the interior thereof;
(b) a second coil wound in a predetermined direction and in an elongated oval shape having a major and minor axis. Said second coil having a first geometrical distance along the major axis which exceeds the distance between the third and fourth strings of a multistringed musical instrument adapted to use the electromagnetic pickup and a second geometrical distance along the minor axis which is substantially less than that along the major axis, said second coil including means defining a second opening through the interior thereof;
(c) a third coil wound in a predetermined direction and in an elongated oval shape having a major and minor axis. Said third coil having a first geometrical distance along the major axis which exceeds the distance between the fifth and sixth strings of a multistringed musical instrument adapted to use the electromagnetic pickup and a second geometrical distance along the minor axis which is substantially less than that along the major axis, said third coil including means defining a third opening through the interior thereof;
(d) a fourth coil wound in a predetermined direction and in an elongated oval shape having a major and minor axis. Said fourth coil having a first geometrical distance along the major axis which exceeds the distance between the first and sixth strings of a multistringed musical instrument adapted to use the electromagnetic pickup and a second geometrical distance along the minor axis which is substantially less than that along the major axis, said fourth coil including means defining a fourth opening through the interior thereof. Placing said fourth coil to encompass said first, second, and third coil in said fourth opening;
(e) a permanent magnet means having a north magnetic pole and a south magnetic pole positioned in said coil openings positioned therein so as to be adapted to be adjacent to and magnetically coupled with a string of said multistringed musical instrument;
(f) said permanent magnet means further including a plurality of spaced, cylindrically shaped permanent magnet elements having an axial length which enables the permanent magnet elements to be located within the hollowed-out central cavity and a diameter which is less than the second geometrical dimension of the minor axis of said first opening;
(g) said permanent magnet means further including a plurality of spaced, cylindrically shaped permanent magnet elements having an axial length which enables the permanent magnet elements to be located within the hollowed-out central cavity and a diameter which is less than the second geometrical dimension of the minor axis of said second opening;
(h) said permanent magnet means further including a plurality of spaced, cylindrically shaped permanent magnet elements having an axial length which enables the permanent magnet elements to be located within the hollowed-out central cavity and a diameter which is less than the second geometrical dimension of the minor axis of said third opening;
(i) coil connecting means operatively coupled to said first coil, said second coil, said third coil, and said fourth coil in at least one of series opposition and single coil configuration, said coil connecting means and coil assembly being adapted to produce a magnetic field which traverses a path from the hollowed-out central cavity of the coil assemblies, through said permanent magnet means to a said string of a said multistringed musical instrument formed of ferromagnetic material defining a magnetic flux path, the reluctance of which is varied in response to the vibration of a said string of a said multistringed musical instrument which is adapted to vary the magnetic field inducing a voltage into said coils which varies in amplitude and frequency.

2. The electromagnetic pickup of claim 1 wherein the end of each cylindrically shaped permanent magnet means is adapted to be positioned adjacent a string is substantially coplanar with the other ends of each of the cylindrically shaped magnet means which are adapted to likewise be positioned adjacent to the other strings, all of which are adapted to define a gap having a selected distance and wherein the opposite ends of each of the cylindrically shaped magnet members are in an even or staggered relationship.

3. The electromagnetic pickup of claim 1 wherein said first coil, said second coil, said third coil, and said fourth coil are wound in the same direction.

4. The electromagnetic pickup of claim 1 wherein each cylindrically shaped permanent magnet element has a selected axial length.

5. An electromagnetic pickup comprising of:
(a) a substantially planar support member
(b) a first coil form formed of a non magnetic material having an elongated oval shape and including means for defining a first wire receiving channel around the periphery thereof, said first coil form having a first geometrical dimension along the major axis of the elongated oval shape which exceeds the distance between the first and second strings of said guitar adapted to use the electromagnetic pickup, said coil form including means for defining a first opening which exceeds through the interior thereof.
(c) a first wire coil wound in a first direction in the first wire-receiving channel of said first coil form.
(d) a second coil form formed of a non magnetic material having an elongated oval shape and including means for defining a first wire receiving channel around the periphery thereof, said second coil form having a first geometrical dimension along the major axis of the elongated oval shape which exceeds the distance between the third and fourth strings of said guitar adapted to use the electromagnetic pickup, said coil form including means for defining a first opening which exceeds through the interior thereof.
(e) a second wire coil wound in a first direction in the first wire-receiving channel of said second coil form.
(f) a third coil form formed of a non magnetic material having an elongated oval shape and including means for defining a first wire receiving channel around the periphery thereof, said third coil form having a first geometrical dimension along the major axis of the elongated oval shape which exceeds the distance between the fifth and sixth strings of said guitar adapted to use the electromagnetic pickup, said coil form including means for defining a first opening which exceeds through the interior thereof.
(g) a third wire coil wound in a first direction in the first wire-receiving channel of said third coil form.
(h) a fourth wire coil wound in a first direction, said fourth coil having a first geometrical dimension along the major axis of the elongated oval shape which exceeds the distance between the first and sixth strings of said guitar adapted to use the electromagnetic pickup, said fourth coil includes means to define a first opening which exceeds through the interior thereof.
(i) a means for operatively selectively connecting the first wire coil of said first coil form with said second wire coil,
(j) a means for operatively selectively connecting the second wire coil of said second coil form with said third wire coil,
(k) a means for operatively selectively connecting the third wire coil of said third coil form with said fourth wire coil,
(l) a permanent magnet means having a magnetic north pole and a magnetic south pole positioned in said hollowed out central cavity with one of said magnetic north pole and said magnetic south pole being adapted to be positioned in the hollowed out central cavity such that when the electromagnetic pickup is positioned on a guitar at least one of said magnetic north pole and magnetic south pole are adapted to magnetically couple the strings.
(m) said permanent magnetic means further including a plurality of spaced, cylindrically shaped permanent magnet elements having axial lengths which enable the permanent magnet elements to be located within the hollowed out central cavity and a diameter which is less than the second geometrical dimension of the minor axis of said first opening, said second opening, and said third opening and wherein any of the cylindrical shaped permanent magnet elements have a dimension that is similar or diverse, said cylindrically shaped permanent magnetic elements being positioned in said hollowed out central cavity with the axis thereof in spaced parallel relationship to each other.

6. A method for electromagnetically picking up vibrations from ferromagnetic strings on multistringed musical instruments comprising the steps of:
(a) positioning at a selected location and gap distance relative to the strings of a multistringed musical instrument a coil assembly.

7. The method of claim 6 further comprising the step of amplifying the output signal.

8. An electrical pickup for a stringed musical instrument having ferromagnetic strings, said pickup comprising of:
(a) a plurality of coil assemblies
(b) each of said coil assemblies including a plurality of permanent magnet members
(c) each of said plurality of coils being electrically connected in series
(d) means for connecting the outputs of said coil assemblies
(e) means for supporting said plurality of coil assemblies on a multistringed musical instrument having ferromagnetic strings with at least one string passing over said permanent magnet members.

9. A pickup of claim 8 in which the coils are respectively disposed on a set of bobbins wherein said bobbins, coils and pole pieces are formed into an integral assembly.
